(19) United States
(12) Patent Application Publication
(10) Pub. No.: US 2008/0110878 A1
(43) Pub. Date: May 15, 2008

(54) NONWOVEN MICROWAVE THAWING APPARATUS

(75) Inventors: Thomas E. Haskett, Oakdale, MN (US); Mark W. Nelson, Lino Lakes, MN (US); Diane L. Regnier, Stillwater, MN (US); Diane R. Wolk, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/558,136

(22) Filed: Nov. 9, 2006

(51) Int. Cl. H05B 6/80

(52) U.S. Cl. 219/730; 426/524

(57) ABSTRACT

A food thawing article for evenly thawing frozen food in a microwave is disclosed. The food thawing article comprises an impermeable film backing, an absorbent layer adjacent the impermeable film backing, and a liquid permeable surface layer comprising a plurality of apertures covering the absorbent layer, opposite the impermeable film backing. A liquid is dispersed throughout the absorbent layer. The impermeable film backing is placed adjacent a frozen food item such that when the food thawing article is exposed to microwave energy, the liquid is heated and the heat is transferred to the food to thaw the food.

### BACKGROUND

The present invention relates to a microwave thawing apparatus. In particular, the present invention relates to a microwave thawing apparatus with a liquid absorbent layer.

Many consumers will purchase frozen food items such as meat, vegetables, and fruit because of the convenient of having food in the home ready to use. To use these items for cooking and then consumption, these items are typically first thawed. After the food is thawed, then the user may cook the food. Consumers are looking for faster and faster ways for preparing foods to eat healthy. The step of thawing the food before cooking the food requires either preplanning of the menu or fast methods of thawing.

Thawing the food involves raising the temperature of the food above the freezing point of the fluid, generally water, contained within the food that is creating the sold state of the frozen item. However, thawing the food properly and safely also involves not allowing the temperature to get too warm for too long of a period of time, which for some types of perishable food, like meat, promotes excessive bacterial growth.

Various methods of thawing frozen food exist. The frozen food may be placed on a countertop, exposed to the air temperature. However, air is a poor conductor of heat, so this method involves leaving the frozen food exposed to too high of a temperature for too long of a time period before the entire food item is thawed. Therefore, excessive bacteria growth may take place on the food.

The frozen food may be placed in a refrigerator, where the air is at a temperature above the freezing point of water but below a temperature where accelerated bacteria growth will occur. Although, this method does not present the sanitary problems of thawing on the countertop, as stated above, air is a poor conductor of heat. Therefore, to thaw a frozen food item in the refrigerator often takes too long for a consumer to be able to use the frozen food for cooking within a few hours, and especially within a few minutes.

Water is a much better conductor of heat than air. Therefore, frozen food may be placed in water, either hot or cold. Placing the food in hot water may present the bacteria growth problems identified above if the food is exposed to the hot water for too long. For example, a large, frozen turkey would require a significant amount of time for thawing even in warm water. Also, placing the food in hot water may begin to prematurely cook portions of the food. Placing the food in cold water does not present a significant bacteria growth problems, but may take longer to thaw the food than the consumer wishes to spend thawing the food. Additionally, thawing directly in water may be messy and may take up space in the sink basin for which the user may wish to use for other purposes.

Microwave ovens can be used to thaw frozen food. Most microwave ovens have a defrost feature, which typically is either a reduced power setting, a cycle between an on and an off setting, or a combination of these features. Microwave ovens can typically thaw a frozen food item within minutes.

However, microwaves have uneven heating abilities due in part to the deflection of the microwaves off the sides and bottom of the microwave oven. This unevenness is partially corrected by rotating or stirring the food being heated. However, when thawing frozen food, the edges still tend to begin cooking before the whole food item is thawed. This is in part due to the edges being thinner and more microwaves penetrating the edges. Although the time to thaw in the microwave is relatively short and is a sanitary method, the unevenness of thawing in a microwave presents an undesirable problem. There is a need for an improved method of quickly, evenly, and safely thawing frozen food within a microwave oven.

### SUMMARY

A food thawing article is disclosed that assists in quickly, evenly, and safely thawing frozen food within a microwave oven. Throughout the disclosure the following definitions have been assigned. “Food” means any edible item, whether solid or liquid. “Frozen” means that the fluids contained within the food are in a solid state. “Thawed” means that the fluids contained within the food are at least partially in a liquid state. “Cooked” means that the fluids contained within the food are at least partially in a vapor state. “To thaw” means to prepare food to cook. “To cook” means to prepare food to eat. However, it is understood that in some instances food does not need to be cooked to be eaten and can be eaten in a thawed stated.

In one embodiment, a food thawing article comprises an impermeable film backing, an absorbent layer adjacent the impermeable film backing, and a liquid permeable surface layer comprising a plurality of apertures covering the absorbent layer, opposite the impermeable film backing. A liquid is dispersed throughout the absorbent layer. The impermeable film backing is placed adjacent a frozen food item such that when the food thawing article is exposed to microwave energy, the liquid is heated and the heat is transferred to the food to thaw the food.

In another embodiment, a food thawing article consists of an impermeable film backing and an absorbent layer adjacent the impermeable film backing. A liquid is dispersed throughout the absorbent layer. The impermeable film backing is placed adjacent a frozen food item such that when the food thawing article is exposed to microwave energy, the liquid is heated and the heat is transferred to the food to thaw the food.

In another embodiment, a food thawing article comprises an upper sheet and a lower sheet. The upper sheet comprises a first impermeable film backing, an absorbent layer adjacent the impermeable film backing, a liquid permeable surface layer comprising a plurality of apertures covering the absorbent layer, opposite the impermeable film backing. The lower sheet consists essentially of a second impermeable film backing. The upper sheet is attached to the lower sheet such that the first and second impermeable film backings form a pocket. A liquid is passed through the liquid permeable surface layer and absorbed into the absorbent layer. A frozen food item is placed in the pocket and exposed to microwave energy to heat the liquid and the heat is transferred to the food to thaw the food.

In another embodiment, a method of thawing frozen food is disclosed. The method comprises providing a food thawing article comprising an impermeable film backing, a liquid containing absorbent layer adjacent the impermeable film backing, and a liquid permeable surface layer comprising a plurality of apertures covering the liquid containing absorbent layer, opposite the impermeable film backing. Further, the method comprises placing the impermeable film backing over a frozen food item, exposing the liquid to microwave energy to heat the liquid in the absorbent layer, transferring the heat within the absorbent layer to the frozen food.

### BRIEF DESCRIPTION OF THE DRAWINGS

FIG. 1 is a perspective view of a food thawing article.

FIG. 2 is a sectional view through line 2-2 of FIG. 1.

FIG. 3 is a side view of the food thawing article of FIG. 1 placed over a frozen food.

FIG. 4 is a perspective view of a second embodiment of a food thawing article.

FIG. 5 is a perspective view of a third embodiment of a food thawing article.

FIG. 6 is a perspective view of the food thawing article of FIG. 5 in a roll.

While the above-identified drawings and figures set forth embodiments of the invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of this invention. The figures may not be drawn to scale.

### DETAILED DESCRIPTION

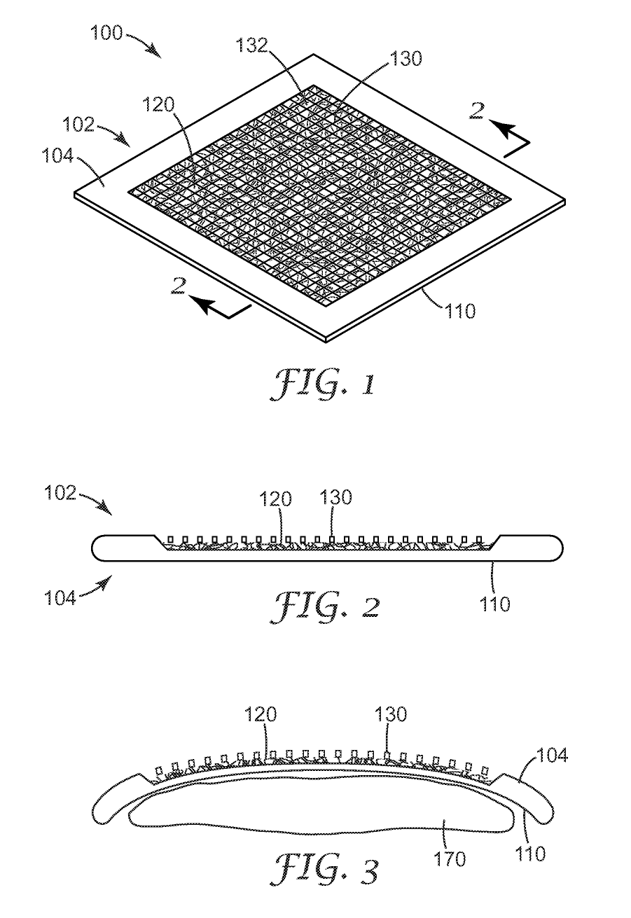

FIGS. 1 to 3 show a first embodiment of a food thawing article 100. FIG. 1 is a perspective view of the food thawing article 100, FIG. 2 is a sectional view through line 2-2 of FIG. 1 and FIG. 3 is a side view of the food thawing article 100 of FIG. 1 placed over a frozen food 170. Common reference numbers are used throughout FIGS. 1 to 3.

The food thawing article 100 includes a first side 102 and a second side 106, that is opposite the first side 102. In this embodiment, the second side 106 includes an impermeable film backing 110. The impermeable film backing 110 is impermeable to liquids. The impermeable film backing 110 may be constructed from such materials as polypropylene, metallocenes, polyamides, polyester, polycarbonate, cellulose triacetate, ethyl cellulose, regenerated cellulose, polyimides, polymethylpentene. The impermeable film backing 110 may be provided in a thickness of from 1 to 8 mils. In some embodiments, it may be desirable to use a material that has a softening above 150° C. It is desirable that the impermeable film backing 110 is vapor proof and microwave oven compatible. To be microwave oven compatible the impermeable film backing 110 must be unaffected by temperatures up to 150° C. The material of the film backing 110 should not emit noxious fumes, shatter, soften, stick, shrink in excess of 30%, burn on char below 150° C.

In this embodiment, the first side 102 of the food thawing article 100 includes a border 104 framing a liquid permeable surface layer 130. The border 104 is typically a liquid impermeable layer. However, the boarder 104 may be constructed of any material and may itself have a liquid absorbent portion.

The liquid permeable surface layer 130 is entirely recessed from the border 104. The liquid permeable surface layer 130 includes a plurality of apertures 132. As shown, the liquid permeable surface layer 130 is a mesh with a nonrandom, uniform distribution of apertures and in particular is in a grid pattern. However, any size, shape, and configuration of the arrangement of the apertures 132 may be included. Additionally, the apertures 132 themselves may be rectangular, circular, or any other geometric or nongeometric shape. The apertures may range in size from 0.1 to 10 mm in width or diameter.

The liquid permeable surface layer 130 may be constructed from such materials as polypropylene, metallocenes, polyamides, polyester, polycarbonate, cellulose triacetate, ethyl cellulose, regenerated cellulose, polyimides, polymethylpentene, which themselves may or may not be permeable to liquid. The liquid permeable surface layer 130 may be provided in a thickness of from 1 to 5 mils and in some embodiments may be of a material that has a softening above 150° C. It is desirable that the liquid permeable surface layer 130 is microwave oven compatible. To be microwave oven compatible the liquid permeable surface layer 130 must be unaffected by temperatures up to 150° C. The material of the permeable surface layer 130 should not emit noxious fumes, shatter, soften, stick, shrink in excess of 30%, burn or char below 150° C.

Between the liquid permeable surface layer 130 and the impermeable film backing 110 is an absorbent layer 120. The absorbent layer 120 is capable of holding and retaining a liquid, such as a water, alcohols, polyols, or oils. The absorbent layer 120 may be constructed from such materials as wovens, nonwovens, paper, tissue, fabrics, sponges, or other similar materials capable of absorbing and retaining liquid. Optionally, the absorbent layer 120 may be provided with a super absorbent material like a fiber or powder such as crosslinked polyacrylates or carboxymethyl cellulose, which when exposed to liquid retains the liquid and forms a gel-like substance. The absorbent layer 120 may also be preloaded with a dielectric that will be dispersed in the liquid that is absorbed into the absorbent layer 120.

The absorbent layer 120 typically is capable of retaining more than 0.009 grams per cm² of absorbent layer 120. In one embodiment, the absorbent layer 120 is capable of retaining 0.01 to 0.150 grams per cm² of absorbent layer 120. In another embodiment, the absorbent layer 120 is capable of retaining 0.02 to 0.07 grams per cm² of absorbent layer 120.

One example of a suitable absorbent layer 120 is a nonwoven blend of 50% PET and 50% Rayon fibers at 50 grams/m². Another example of a suitable absorbent layer is a 5 mm thick sponge such as the Scotch-Brite® Sponge Cloth available from 3M Company of St. Paul, Minn.

The food thawing article 100 shown is in a single sheet construction. However, a plurality of food thawing articles 100 may be provided in a continuous length. In such a construction, each food thawing article 100 may be separated from the next by a perforation line to assist in removal of a single food thawing article.

To use the food thawing article 100, absorbent layer 120 is exposed to a liquid. The liquid may be provided to the absorbent layer 120 by the user. For example, the user may place the food thawing article 100 under water. Alternatively, the liquid may be provided in the absorbent layer 120 to the user in a pre-loaded form. For example, the absorbent layer 120 may include a liquid, such as water or oil, in a packaged form prior to purchase by the user. The liquid permeable surface layer 130, along with the plurality of apertures 132 contained therein, provide access for the liquid to the absorbent layer 120.

Once the absorbent layer 120 is charged with a liquid, the food thawing article 100 is placed over a frozen food item 170, such as shown in FIG. 3. In one embodiment, the impermeable film backing 110 may be provided with an adhesive surface or a recessed adhesive surface that is activated to help secure the food thawing article 100 over and around the food 170.

When placing the food thawing article 100 over the frozen food item 170, the impermeable film backing 110 is placed adjacent the frozen food item 170. Therefore, the absorbent layer 120 is located opposite the impermeable film backing 110 relative to the frozen food item 170. As shown in FIG. 3, the food thawing article 100 covers at least a portion of the frozen food 170. Typically, the food thawing article 100 covers the entire frozen food article 170. The impermeable film backing 110 is advantageously placed adjacent the frozen food item 170 to prevent the liquid contained within the absorbent layer 120 from passing to the frozen food item 170 and to prevent the liquid contained within the frozen food item 170 from passing into the absorbent layer 120. Similarly, the border 104 on the first side 102 serves to prevent the liquid contained within the absorbent layer 120 from spilling beyond the absorbent layer 120. Additionally, the border 104 may provide an area for the user to contact the food thawing article 100 that is not as hot as the absorbent layer 120. The border 104 may provide an area where various printing can be placed.

Once the frozen food item 170 is covered by the food thawing article 100, the food thawing article 100 along with the food item 170 is placed into a microwave oven (not shown) and exposed to microwave energy. The microwave energy may be a “cook” or a “defrost” setting of the microwave oven. Generally, the microwave oven output energy is constant but the time the power is on may vary between a cook setting and a defrost setting. Regardless, the microwave oven generates microwave energy that will provide at least two functions: 1) heat the liquid contained in the absorbent layer and 2) begin to heat the frozen food item 170.

As described above, the function of solely using the microwave energy to heat and thaw the frozen food typically results in nonuniform thawing of the food. Generally, this is because frozen foods have poor conductance and are poor absorbers of microwave energy.

Without being limited by any one particular theory, applicant believes that the liquid within the absorbent layer 120, which itself gets heated by the microwave energy provides an additional source of heat transfer to the frozen food 170. The liquid within the absorbent layer 120 heats up from the microwave energy. Then, that heated liquid, being in close contact with the frozen food 170, transfers the retained heat to the frozen food 170 to provide a more uniform distribution of heat and therefore thawing. The apertures 132 in the liquid permeable surface layer 130 also provide a place for any steam generated by the liquid to escape from the food thawing article 100. Additionally, because the liquid retained within the absorbent layer 120 absorbs some of the microwave energy, the amount of direct microwave energy transmitted to the food is minimized. The food thawing article 100 may also provide a level of insulation of the microwave energy that penetrates the frozen food 170 and begins to heat the frozen food 170. This results in more heat being retained within the frozen food 170 and may provide a more uniform distribution of heat and therefore thawing.

The entire thawing process may take place in the microwave oven. Alternatively, the thawing process may be started in the microwave oven by exposing the food thawing article 100 to microwave energy long enough to heat the liquid contained within the absorbent layer 120. Then, the food thawing article placed over the frozen food article 170 may be place in the refrigerator where the thawing process is completed. It is understood that due to the transfer of the heat within the liquid to the frozen food, the thawing process in the refrigerator, although slower than if entirely carried out in the microwave, is still accelerated as compared to simply placing the frozen food 170 in the refrigerator.

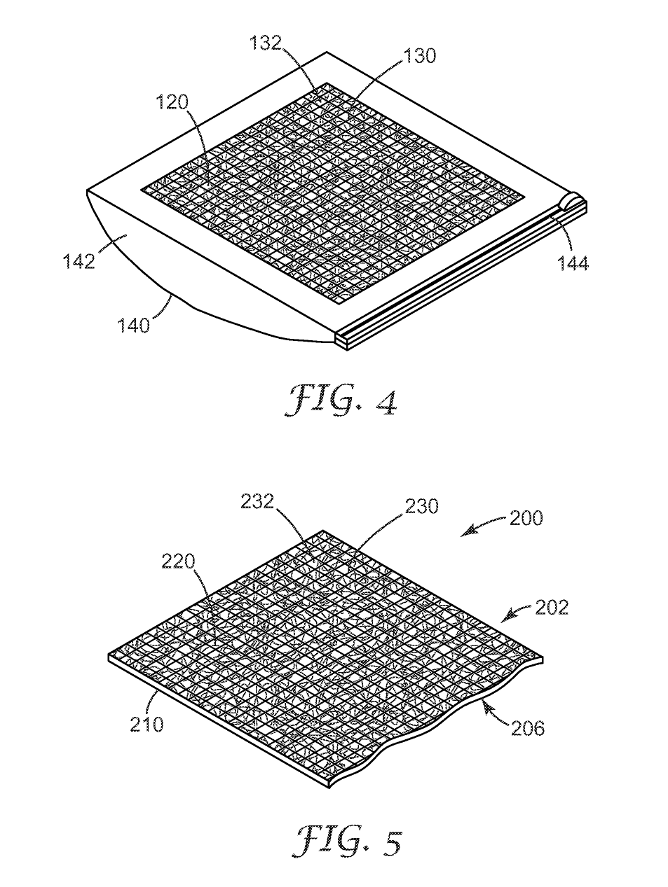

FIG. 4 is a perspective view an embodiment of the food thawing article 100, as shown and described in FIG. 1 to 3. However, the food thawing article 100 shown in FIG. 4 further includes a second impermeable film backing 140 which may have the same material characteristics as the first impermeable film backing 110. This second impermeable film backing 140 is attached to a portion of the food thawing article 100. As shown, the second impermeable film backing 140 is attached at the outer edge of the food thawing article 100. Such attachment may be by ultrasonic welding or a heat seal. However, the second impermeable film backing 140 is not attached entirely around the food thawing article 100. A portion is not attached resulting in an opening (not shown) to an inner pocket 142 being formed. As shown in FIG. 4, the opening (not shown) includes an optional recloseable seal 144, which may optionally allow the bag to be used for food storage. The recloseable seal 144 would allow access through the opening into the pocket 142, when opened. When the recloseable seal 144 is closed, then the opening is closed and the pocket 142 is sealed.

The recloseable seal 144 shown is of the type commonly used for sandwich and freezer bags where a projecting channel slides into a receiving channel. Such a recloseable seal 144 creates an airtight pocket 142. However, and air tight pocket 142 is not necessary and the recloseable seal 144 may be a closure, such as hook and loop or an adhesive seal that may or may not result in an air tight pocket 142.

In this embodiment, the frozen food (not shown) would be placed within the pocket 142. If included, the recloseable seal 144 would be closed. Then, the food thawing article 100 would be used as described above with respect to the description of FIGS. 1-3 for thawing the frozen food.

The food thawing article 100 shown is a single bag. However, a plurality of food thawing articles 100 may be provided in a continuous length. In such a construction, each food thawing article 100 may be separated from the next by a perforation line to assist in removal of a single food thawing article. Also, as with the food thawing article 100 as shown in FIGS. 1-3 a border 104 is included. However, a border 104 is optional.

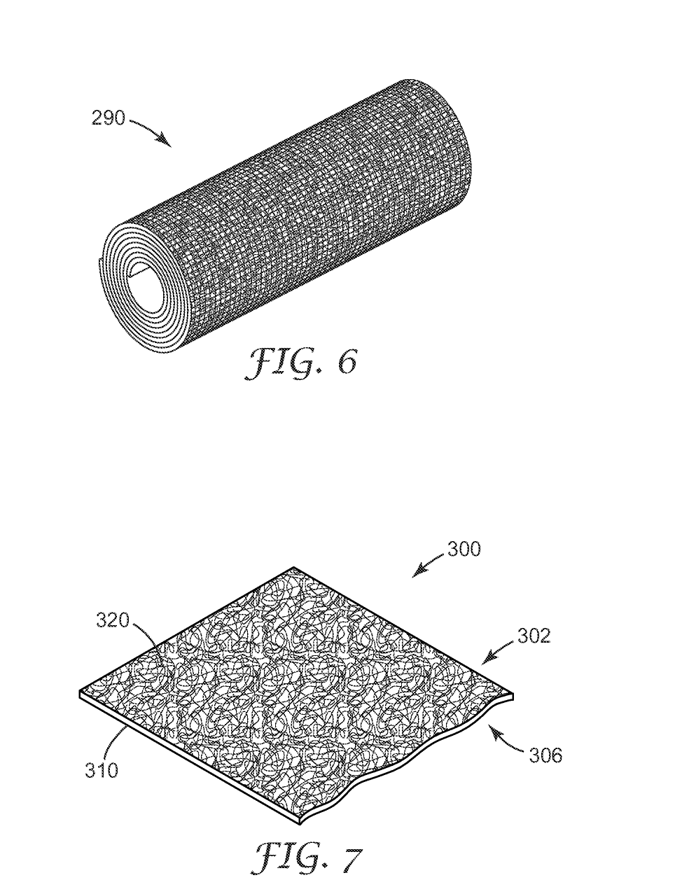

FIG. 5 is a perspective view of a third embodiment of a food thawing article 200, and FIG. 6 is a perspective view of the food thawing article 200 of FIG. 5 in a roll 290. The food thawing article 200 includes a first side 202 and a second side 206, opposite the first side 202. In this embodiment, the second side 206 includes an impermeable film backing 210. The impermeable film backing 210 is impermeable to liquids. The impermeable film backing 110 may be constructed from such materials and provided in thicknesses as was described above.

As distinguished from the embodiment shown and described with respect to FIGS. 1-4, in this embodiment, the first side 202 of the food thawing article 200 does not include a border. Instead the liquid permeable surface layer 230 extends over the entire first side 202 of the food thawing article 200. The liquid permeable surface layer 230 includes a plurality of apertures 232. As shown, the liquid permeable surface layer 230 is a mesh with a nonrandom, uniform distribution of apertures and in particular is a grid pattern. However, any size, shape, and configuration of the arrangement of the apertures 232 may be included. The liquid permeable surface layer 230 may be constructed from such materials and thicknesses as was described above.

Between the liquid permeable surface layer 230 and the impermeable film backing 210 is an absorbent layer 220. The absorbent layer 220 is capable of holding and retaining a liquid as described above. The absorbent layer 220 may be constructed from such materials as wovens, nonwovens, paper, tissue, fabric, sponges, or other similar materials capable of absorbing and retaining liquid. Optionally, the absorbent layer 220 may be provided with a super absorbent material.

As shown in FIG. 5, the food thawing article 200 may be provided in a continuous web of material, as opposed to a single sheet construction such as shown by the embodiments of FIGS. 1-4. When provided in a continuous web, the food thawing article 200 may be rolled and then packaged in a structure such that any length of material can be cut by the user. Such packaging structure may resemble known containers used for delivering cling wrap and aluminum foil where the package contains a cutting mechanism for cutting the food thawing article 200.

To use the food thawing article 200 described in FIGS. 5 and 6, a user will cut a portion of the food thawing article 200 to place over the frozen food (not shown). Then, use of the food thawing article 200 would proceed as was described above with respect to FIGS. 1-3.

FIG. 7 is a perspective view of a fourth embodiment of a food thawing article 300. The food thawing article 300 includes a first side 302 and a second side 306. In this embodiment, the second side 306 includes an impermeable film backing 310. The impermeable film backing 300 is impermeable to liquids. The impermeable film backing 310 may be constructed from such materials and thicknesses as was described above.

As distinguished from the embodiments shown in FIGS. 1-4 and FIGS. 5-6, in this embodiment, the first side 302 of the food thawing article 300 does not include a liquid permeable surface layer. Instead, the first side 302 of the food thawing article 300 includes an absorbent layer 320. In the embodiment shown in FIG. 7, the absorbent layer 320 extends across the entire first side 302. However, the absorbent layer 320 may be framed by a border, similar to that shown in FIG. 1. The border could be a liquid impermeable or a liquid permeable, which itself may have absorbent capacity. The absorbent layer 320 is capable of holding and retaining a liquid as described above. The absorbent layer 320 may be constructed from such materials as wovens, nonwovens, paper, tissue, fabric, sponges, or other similar materials capable of absorbing and retaining liquid. Optionally, the absorbent layer 320 may be provided with a super absorbent material when exposed to liquid retains the liquid and forms a gel-like substance.

The food thawing article 300 may be provided in cut sections such as shown in FIG. 1, provided with a second impermeable backing for a bag such as shown in FIG. 4, or may be provided in a continuous length that may be rolled such as shown in FIG. 7. To use the food thawing article 300 described in FIG. 7, a user will place a portion of the food thawing article 300 over the frozen food (not shown). Then, use of the food thawing article 300 would proceed as was described above with respect to FIGS. 1-3.

It is understood that for any of the embodiments shown and described, additional absorbent layers or impermeable backing layers may be provided. For example, as was shown in FIG. 4 a second impermeable backing layer is included. Additionally, a second absorbent layer may be provided such that there is absorbent material above and below the food item. The second absorbent material may be place directly adjacent the food item or may be separated from the food item by a second permeable layer or second impermeable backing layer.

Although specific embodiments of this invention have been shown and described herein, it is understood that these embodiments are merely illustrative of the many possible specific arrangements that can be devised in application of the principles of the invention. Numerous and varied other arrangements can be devised in accordance with these principles by those of ordinary skill in the art without departing from the spirit and scope of the invention. Thus, the scope of the present invention should not be limited to the structures described in this application, but only the structure described by the language of the claims and the equivalents of those structures.

### EXAMPLES

### Test Methods

### Microwave Testing

The microwave oven used for testing was a countertop turntable microwave oven (1.1 cubic fee, 1100 watt, Model No. JES1136WK, available from General Electric Company, Fairfield, Conn.). The heating cycle used for testing was one minute on the highest power setting (100% power).

Temperatures were measured using an Infrared pyrometer (Scotchtrak™ Heat Tracer, Model No. IR-16EXL3, available from 3M Company, St. Paul, Minn.). If the cell contained both an ice portion and water, the percent of ice was estimated and assumed to have a temperature of 32° F. The water temperature was measured and a composite average was calculated based on both temperatures and the amount of ice present.

### Example 1

### (Control)

A conventional fourteen position plastic ice cube tray having two row containing seven cells in each row was used to prepare ice cubes. Cells in the left row were numbered 1-7 while cells in the right row were numbered 8-14 such that Cell Number 1was adjacent to Cell Number 8, Cell Number 2 was adjacent to Cell Number 9, Cell Number 3 was adjacent to Cell Number 10, and so on. The ice cubes were prepared with water amounts sized and configured to simulate an average frozen chicken breast weighing approximately 200 grams. Since the conductance of water equals 1 and the conductance of chicken equals 0.8, the amount of water needed was calculated to be 80% of 200 grams, of approximately 160 grams. Cell Number 1, 2, 6, 7, 8, 9, and 14 and no water. Cell Number 3 contained 25.5 grams of water. Cell Number 4 contained 23.0 grams of water. Cell Number 5 contained 20.5 grams of water. Cell Number 10 contained 28.0 grams of water. Cell Number 11 contained 25.5 grams of water. Cell Number 12 contained 23.0 grams of water. Cell Number 13 contained 20.5 grams of water

The frozen ice cube tray was sealed and was then placed in the microwave oven for the heating cycle. The temperatures of the filled cells were then measured as described above. Five of the seven cells were still frozen while other cells had temperatures as high as 70° F. The average temperature was about 38.1° F. with a standard deviation of 21.5° F. The data (in ° F.) is summarized in Table 1.

### Example 2

An 8 inch×15 inch piece of a nonwoven material (weighing approximately 6 grams) having 15 grams of tap water added to it (approximately 22 mg of water per square centimeter of nonwoven) was placed over a frozen ice cube tray identical to that described in the Control above. The nonwoven material used as of Product No. SX-313 T (a blend of 50% by weight of polyester fiber, 25% by weight Tencel® cellulosic fiber and 25% by weight rayon fiber having a basis weight of 50 grams per square meter), available from Green Bay Nonwovens, Green Bay, Wis. The covered tray was then placed in the microwave oven for the heating cycle. The temperatures of the filled cells were then measured as described above. Two of the seven cells were still frozen. The average temperature was 39.6° F. was a standard deviation of 8.6° F. The highest temperature measured was 56.0° F. and the lowest temperature measured was 32.0° F. The data (in ° F.) is summarized in Table 1.

### Example 3

An 8 inch×15 inch piece of a nonwoven material (weighing approximately 11 grams) having 25 grams of tap water added to it (approximately 37 mg of water per square centimeter of nonwoven) was placed over a frozen ice cube tray identical to that described in the Control above. The nonwoven material used was Vicell™ 6309 (a cellulosic nonwoven having a basis weight of 70 grams per square meter), available from Buckeye Technologies, Memphis Tenn. The covered tray was then placed in the microwave oven for the heating cycle. The temperatures of the filled cells were then measured as described above. Five of the seven cells were still frozen. The average temperature was 28.1° F. with a standard deviation of 5.8° F. The highest temperature measured was 35.0° F. and the lowest temperature measured was 20.0° F. The data (in ° F.) is summarized in Table 1.

### Example 4

An 8 inch×15 inch piece of Vicell™ 6309 nonwoven material (weighting approximately 11 grams) having 50 grams of tap water added to it (approximately 74 mg of water per square centimeter of nonwoven) was placed over a frozen ice cube tray identical to that described in the Control above. The covered tray was then placed in the microwave oven for the heating cycle. The temperature of the filled cells were then measured as described above. Three of the seven cells were still frozen. The average temperature was 33.0° F. with a standard deviation of 2.0° F. The highest temperature measured was 35.0° F. and the lowest temperature measured was 31.0° F. The data (in ° F.) is summarized in Table 1.

TABLE 1

| | Cell | Cell | | | | | |
|---|---|---|---|---|---|---|---|
| | 3 | 4 | Cell 5 | Cell 10 | Cell 11 | Cell 12 | Cell 13 |
| Control | 19 | 27 | 23 | 31 | 70 | 29 | 68 |
| Example 2 | 36 | 32 | 45 | 36 | 40 | 32 | 56 |
| Example 3 | 21 | 20 | 35 | 29 | 28 | 30 | 34 |
| Example 4 | 31 | 31 | 33 | 35 | 35 | 31 | 35 |

Examples 1-3 demonstrate that using the food thawing article resulted in a more even distribution of heat when thawing in the microwave.

What is claimed is:

1. A food thawing article comprising:
an impermeable film backing;
an absorbent layer adjacent the impermeable film backing;
a liquid permeable surface layer comprising a plurality of apertures covering the absorbent layer, opposite the impermeable film backing;
wherein a liquid is dispersed throughout the absorbent layer; and
wherein the impermeable film backing is placed adjacent a frozen food item such that when the food thawing article is exposed to microwave energy, the liquid is heated and the heat is transferred to the food to thaw the food.

2. The food thawing article of claim 1, wherein the absorbent layer is selected from the group consisting of a nonwoven, a sponge, woven, knitted, and paper.

3. The food thawing article of claim 1, wherein the liquid is selected from the group consisting of water, oils, alcohols and polyols.

4. The food thawing article of claim 1, wherein the liquid is preloaded in the absorbent layer.

5. The food thawing article of claim 1, wherein the impermeable film backing forms a perimeter and the absorbent layer is entirely recessed from the perimeter of the impermeable film backing.

6. The food thawing article of claim 1, wherein the food thawing article is in the form of a continuous sheet provided in a roll form.

7. The food thawing article of claim 1, further comprising a lower sheet consisting essentially of a second impermeable film backing attached to the impermeable film backing such that a pocket is formed.

8. The food thawing article of claim 7, further comprising a resealable closure at the pocket.

9. The food thawing article of claim 1, wherein impermeable film backing includes a recessed adhesive.

10. The food thawing article of claim 1, wherein the absorbent layer further includes a super absorbent material.

11. The food thawing article of claim 1, further comprising:
a second absorbent layer positioned opposite the absorbent layer, wherein the food is positioned between the absorbent layer and the second absorbent layer.

12. A food thawing article consisting of:
an impermeable film backing; and
an absorbent layer adjacent the impermeable film backing;
wherein a liquid is dispersed throughout the absorbent layer; and
wherein the impermeable film backing is placed adjacent a frozen food item such that when the food thawing article is exposed to microwave energy, the liquid is heated and the heat is transferred to the food to thaw the food.

13. A food thawing article comprising:
an upper sheet comprising:
a first impermeable film backing;
an absorbent layer adjacent the impermeable film backing
a liquid permeable surface layer comprising a plurality of apertures covering the absorbent layer, opposite the impermeable film backing;
a lower sheet consisting essentially of a second impermeable film backing;
wherein the upper sheet is attached to the lower sheet such that the first and second impermeable film backings form a pocket;
wherein a liquid is passed through the liquid permeable surface layer and absorbed into the absorbent layer, and wherein a frozen food item is placed in the pocket and exposed to microwave energy to heat the liquid and the heat is transferred to the food to thaw the food.

14. The food thawing article of claim 13, wherein the first impermeable film backing forms a perimeter and the absorbent layer is entirely recessed from the perimeter of the impermeable film backing.

15. The food thawing article of claim 13, further comprising a resealable closure at the pocket.

16. The food thawing article of claim 13, wherein the lower sheet further comprises a second absorbent layer.

17. A method of thawing frozen food comprising:
providing a food thawing article comprising an impermeable film backing, a liquid containing absorbent layer adjacent the impermeable film backing, and a liquid permeable surface layer comprising a plurality of apertures covering the liquid containing absorbent layer, opposite the impermeable film backing;
placing the impermeable film backing over a frozen food item;
exposing the liquid to microwave energy to heat the liquid in the absorbent layer;
transferring the heat within the absorbent layer to the frozen food.

18. The method of claim 17 further comprising:
placing the frozen food with the heated food thawing article in the refrigerator until the frozen food is thawed.
